(19) United States
(12) Patent Application Publication
(10) Pub. No.: US 2025/0317226 A1
(43) Pub. Date: Oct. 9, 2025

(54) METHOD AND APPARATUS FOR MEASURING AND REPORTING CROSS LINK INTERFERENCE IN COMMUNICATION SYSTEM

(71) Applicant: ELECTRONICS AND TELECOMMUNICATIONS RESEARCH INSTITUTE, Daejeon (KR)

(72) Inventors: Junhyeong KIM, Daejeon (KR); IL GYU KIM, Daejeon (KR); Hee Sang CHUNG, Daejeon (KR)

(73) Assignee: ELECTRONICS AND TELECOMMUNICATIONS RESEARCH INSTITUTE, Daejeon (KR)

(21) Appl. No.: 19/169,834

(22) Filed: Apr. 3, 2025

(30) Foreign Application Priority Data
Apr. 5, 2024 (KR) 10-2024-0046911
Mar. 31, 2025 (KR) 10-2025-0041522

(51) Int. Cl. H04B 17/345; H04B 17/318; H04L 5/00; H04W 24/10

(52) U.S. Cl. CPC H04B 17/345; H04B 17/318; H04L 5/0048; H04W 24/10

(57) ABSTRACT

A method of a communication node may include: transmitting a first cross-link interference-reference signal (CLI-RS) to a second communication node; receiving a first timing adjustment value based on the first CLI-RS from the second communication node or a third communication node; adjusting a transmission timing based on the first timing adjustment value; transmitting a second CLI-RS to the second communication node based on the adjusted transmission timing; and receiving a received signal strength for the second CLI-RS from the second communication node.

### CROSS-REFERENCE TO RELATED APPLICATIONS

This application claims priority to Korean Patent Applications No. 10-2024-0046911, filed on Apr. 5, 2024, and No. 10-2025-0041522, filed on Mar. 31, 2025, with the Korean Intellectual Property Office (KIPO), the entire contents of which are hereby incorporated by reference.

### BACKGROUND

### 1. Technical Field

The present disclosure relates to a technique for measuring and reporting cross-link interference in a communication system, and more particularly, to a technique for measuring and reporting cross-link interference in a communication system in which, when a first communication node transmits a reference signal for cross-link interference measurement to a second communication node, the second communication node reports a measurement result for the reference signal for cross-link interference measurement to the first communication node.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

A communication system may use a frequency division duplex (FDD) communication scheme and/or a time division duplex (TDD) communication scheme. In particular, an NR communication system may use a dynamic TDD communication scheme. In a communication system using the dynamic TDD communication scheme, cross-link interference (CLI) may occur between a downlink (DL) signal and an uplink (UL) signal. To measure the cross-link interference, the communication system may use a CLI-reference signal (CLI-RS) for CLI measurement. A first communication node may transmit the CLI-RS for CLI measurement to a second communication node, and the second communication node may receive the CLI-RS for CLI measurement and report a measurement result to the first communication node. Accurate measurement by the second communication node may be necessary to minimize cross-link interference. To this end, timing synchronization between the first communication node and the second communication node may be required.

### SUMMARY

The present disclosure for resolving the above-described problems is directed to providing a method and an apparatus for measuring and reporting cross-link interference in a communication system in which, when a first communication node transmits a reference signal for cross-link interference measurement to a second communication node, the second communication node reports a measurement result for the reference signal for cross-link interference measurement to the first communication node.

A method for measuring and reporting cross-link interference in a communication system, which is performed by a first communication node according to a first exemplary embodiment of the present disclosure, may comprise: transmitting a first cross-link interference-reference signal (CLI-RS) to a second communication node; receiving a first timing adjustment value based on the first CLI-RS from the second communication node or a third communication node; adjusting a transmission timing based on the first timing adjustment value; transmitting a second CLI-RS to the second communication node based on the adjusted transmission timing; and receiving a received signal strength for the second CLI-RS from the second communication node.

Each of the first CLI-RS and the second CLI-RS may be at least one of a sounding reference signal (SRS), a physical uplink control channel (PUCCH), a demodulation reference signal (DMRS) of a PUCCH, a DMRS of a physical uplink shared channel (PUSCH), or a physical random access channel (PRACH).

The method may further comprise: before transmitting the first CLI-RS, receiving a transmission indication signal for the first CLI-RS from a base station; and before transmitting the second CLI-RS, receiving a transmission indication signal for the second CLI-RS from the base station.

The adjusting of the transmission timing based on the first timing adjustment value may comprise: deriving a second timing adjustment value by applying the first timing adjustment value to an uplink timing advance value; and adjusting the transmission timing by using the second timing adjustment value.

In the adjusting of the transmission timing based on the second timing adjustment value, the first communication node may configure one or more symbols located before or after a symbol of the second CLI-RS as guard symbols, and adjust a transmission timing of the symbol of the second CLI-RS within a section of the guard symbols by applying the second timing adjustment value.

In the adjusting of the transmission timing based on the first timing adjustment value, the first communication node may adjust the transmission timing by applying the first timing adjustment value in units of slots.

The first CLI-RS and the second CLI-RS may be transmitted in a periodic, aperiodic or semi-persistent manner.

The received signal strength may be at least one of a reference signal received power (RSRP), a reference signal received quality (RSRP), or a received signal strength indication (RSSI).

A method for measuring and reporting cross-link interference in a communication system, which is performed by a second communication node according to a second exemplary embodiment of the present disclosure, may comprise: receiving a first cross-link interference-reference signal (CLI-RS) from a first communication node; deriving a timing adjustment value based on the first CLI-RS; transmitting the timing adjustment value to the first communication node; receiving a second CLI-RS from the first communication node; measuring a received signal strength for the second CLI-RS; and transmitting the received signal strength to the first communication node or a third communication node.

The deriving of the timing adjustment value based on the first CLI-RS may comprise: measuring a reception time of the first CLI-RS; deriving a time difference using a reception boundary and the reception time; and deriving the timing adjustment value by quantizing the time difference.

The deriving of the timing adjustment value may comprise: measuring a reception time of the first CLI-RS; deriving a time difference using a reception boundary and the reception time; deriving a timing advance value by quantizing the time difference; and configuring an error value between an uplink timing advance value and the timing advance value as the timing adjustment value.

The timing adjustment value may be transmitted to the first communication node via the third communication node.

An interference measurement band of the second CLI-RS may be at least one of a downlink bandwidth part (BWP), an uplink BWP, a downlink subband, or an uplink subband.

The method may further comprise: before receiving the second CLI-RS, adjusting a reception timing based on the timing adjustment value.

The reception timing may be adjusted in units of symbols or slots.

An apparatus for measuring and reporting cross-link interference in a communication system, which is a first communication node according to a third exemplary embodiment of the present disclosure, may comprise: at least one processor, wherein the at least one processor may cause the first communication node to perform: transmitting a first cross-link interference-reference signal (CLI-RS) to a second communication node; receiving a first timing adjustment value based on the first CLI-RS from the second communication node or the third communication node; adjusting a transmission timing based on the first timing adjustment value; transmitting a second CLI-RS to the second communication node based on the adjusted transmission timing; and receiving a received signal strength for the second CLI-RS from the second communication node.

In the adjusting of the transmission timing based on the first timing adjustment value, the at least one processor may cause the first communication node to perform: deriving a second timing adjustment value by applying the first timing adjustment value to an uplink timing advance value; and adjusting the transmission timing by using the second timing adjustment value.

In the adjusting of the transmission timing based on the first timing adjustment value, the at least one processor may cause the first communication node to adjust the transmission timing by applying the first timing adjustment value in units of slots.

According to exemplary embodiments the present disclosure, a first communication node may transmit a reference signal for CLI measurement to a second communication node. The second communication node may receive the reference signal for CLI measurement from the first communication node, measure a time difference for the received reference signal, and deliver the measured time difference to the first communication node. The first communication node may receive the time difference from the second communication node and adjust a transmission timing by reflecting the received time difference. The first communication node may apply the adjusted transmission timing and transmit a reference signal for CLI measurement to the second communication node. The second communication node may receive the reference signal for CLI measurement, perform measurement on the received reference signal to generate a measurement result, and report the measurement result to the first communication node. Accordingly, the first communication node and the second communication node can acquire timing synchronization, thereby obtaining accurate CLI measurement results.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram for describing cross-link interference.

FIG. 4 is a conceptual diagram for describing UE-to-UE CLI.

FIG. 5 is a sequence chart illustrating exemplary embodiments of a method for measuring and reporting UE-to-UE CLI in a communication system.

FIGS. 6A and 6B are conceptual diagrams for describing exemplary embodiments for alignment of a transmission frame boundary and a reception frame boundary.

FIG. 7 is a conceptual diagram for describing exemplary embodiments of a timing advance of a reference signal for CLI measurement in units of slots.

FIG. 8 is a conceptual diagram for describing exemplary embodiments of a timing advance of a reference signal for CLI measurement in units of symbols.

FIG. 9 is a sequence chart illustrating exemplary embodiments of a method for measuring and reporting gNB-to-gNB CLI in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

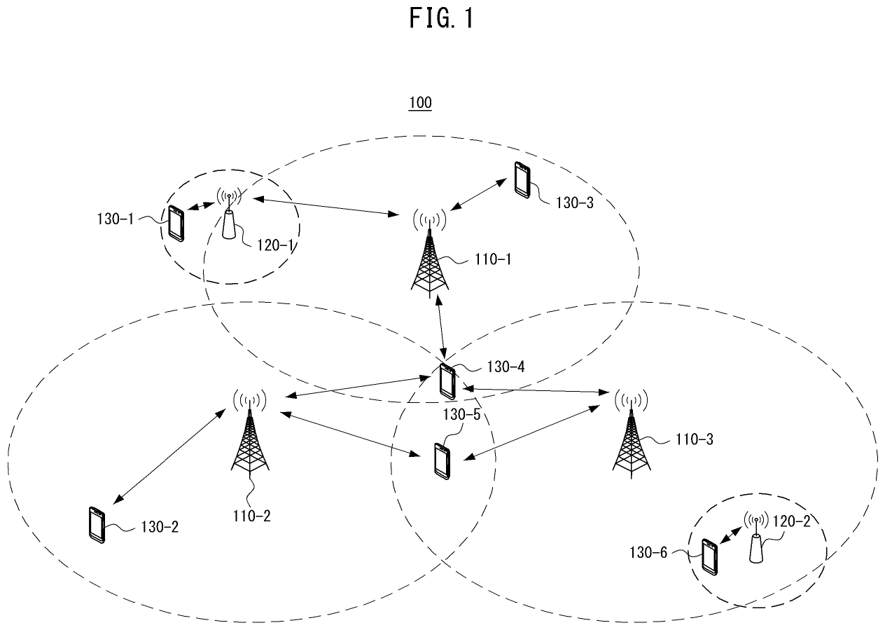

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3 GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

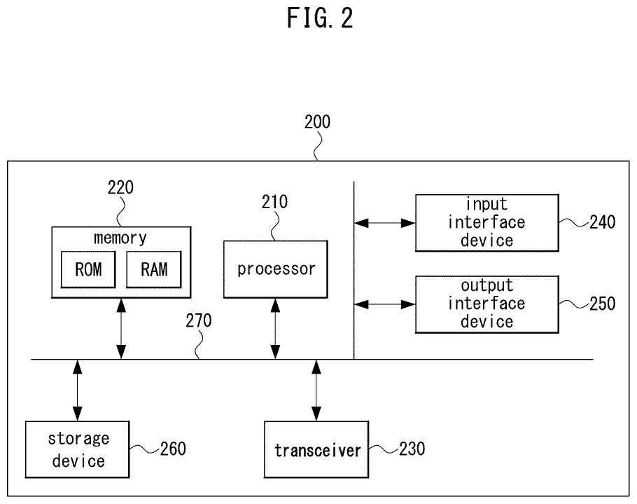

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like.

Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, a 5G NR communication system may support duplexing flexibility in a paired spectrum (or frequency division duplex, FDD) and an unpaired spectrum (or time division duplex, TDD). In particular, the 5G NR communication system has been designed to use a dynamic TDD scheme. The communication system using the dynamic TDD scheme may support dynamic and flexible time allocation for downlink (DL) and uplink (UL). The communication system using the dynamic TDD scheme may allow dynamic resource allocation per cell in a multi-cell environment.

In such cases, interference may occur between DL and UL. This interference may be referred to as cross-link interference (CLI). The CLI may be largely classified into CLI between base stations (i.e. gNB-to-gNB CLI) and CLI between terminals (i.e. user equipment (UE)-to-UE CLI). The UE-to-UE CLI refers to interference in which a UL signal transmitted by a terminal of a specific cell affects a DL signal received by a terminal of another cell. The gNB-to-gNB CLI refers to interference in which a DL signal transmitted by a specific cell affects a UL signal received by another cell.

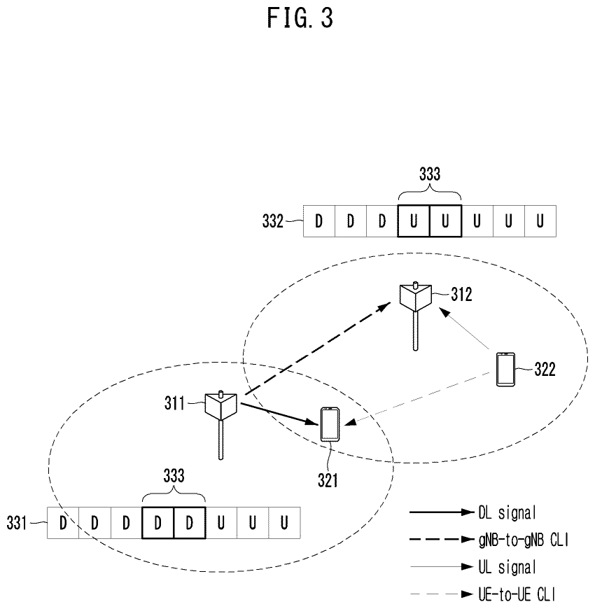

FIG. 3 is a conceptual diagram for describing cross-link interference.

Referring to FIG. 3, a communication system may include a plurality of base stations 311 and 312 and a plurality of terminals 321 and 322. The first base station 311 may provide a service to the first terminal 321. For example, the first base station may transmit a DL signal to the first terminal. The first terminal may receive the DL signal from the first base station. The first terminal may transmit a UL signal to the first base station. The first base station may receive the UL signal from the first terminal. The second base station 312 may provide a service to the second terminal 322. For example, the second base station may transmit a DL signal to the second terminal. The second terminal may receive the DL signal from the second base station. The second terminal may transmit a UL signal to the second base station. The second base station may receive the UL signal from the second terminal.

A part of a frame, subframe, or slot may be allocated for DL transmissions, and the remaining part may be allocated for UL transmissions. For example, the starting symbols of respective slots may be for DL, and the ending symbols of respective slots may be for UL. In a dynamic TDD communication system, the number of DL symbols and/or UL symbols may be dynamically adjusted to adapt to varying traffic patterns. For example, a terminal may receive a video. In this case, the communication system may increase the number of DL symbols and decrease the number of UL symbols in the slots. Conversely, for a terminal transmitting more data than receiving, the communication system may increase the number of UL symbols and decrease the number of DL symbols in the slot.

For example, communications between the first terminal and the first base station may involve more DL traffic than UL traffic. A first slot 331 may include more DL symbols and fewer UL symbols. Communications between the second terminal and the second base station may involve more UL traffic than DL traffic. Therefore, a second slot 332 may include more UL symbols than DL symbols. There may be occasions 333 during which UL and DL transmissions occur in the same slot. These occasions may cause cross-link interference.

The first terminal may receive a DL signal from the first base station. In such a situation, the second terminal may transmit a UL signal to the second base station. The first terminal may receive a part of the UL signal transmitted by the second terminal. Depending on relative signal strengths of these signals, the UL signal of the second terminal may interfere with the DL signal for the first terminal.

The first base station may transmit a DL signal to the first terminal. In such a situation, the second base station may receive a UL signal from the second terminal. The second base station may receive a part of the DL signal from the first base station. Depending on relative signal strengths of these signals, the DL signal of the first base station may interfere with the UL signal of the second base station.

To address the CLI issue described above, the 3GPP has discussed CLI mitigation techniques between terminals during the Release 16 standardization phase. In Release 16, the 3GPP has mainly discussed methods for UE-to-UE CLI measurement and reporting, information exchange procedures for network cooperation, and effects of interference that may occur during dynamic UL/DL resource allocation between operators using adjacent frequencies.

The 3GPP has allowed interference measurement at a layer 3 (L3) level for UE-to-UE CLI measurement and reporting. Additionally, the 3GPP agreed to use CLI-received signal strength indicator (CLI-RSSI) and sounding reference signal-reference signal received power (SRS-RSRP) in CLI measurement methods, and has included them in the technical specifications. However, additional studies for CLI handling between base stations of the same operator may be necessary to implement dynamic TDD in commercial NR networks. Accordingly, the 3GPP has conducted additional studies in Release 18 for CLI handling between base stations of the same operator.

TDD may be one of half-duplex schemes. In TDD, a base station may perform transmission and reception by dividing time slots within the same frequency band. TDD may be widely used in current commercial 5G NR and may utilize time-domain resources by dividing them into DL and UL. However, when a base station allocates limited time resources to UL in TDD, problems such as reduced UL coverage, increased communication latency, and reduced UL capacity may occur.

To overcome such limitations, the 3GPP has conducted studies on full duplex communication as a study item (SI) in the Rel-18 standardization phase, positioning it as one of the key features of evolved 5G (5G-Advanced). In full duplex communication, DL and UL may exist simultaneously within a TDD band. Specifically, in the Rel-18 standardization phase, the 3GPP has studied the need for and feasibility of supporting a subband non-overlapping full duplex (SBFD) scheme as a study item.

In the NR duplex SI standardization work of Release 18, the 3GPP has identified deployment scenarios applicable to each of SBFD and dynamic/flexible TDD, and has conducted studies and evaluations on the feasibility of SBFD and its performance including uplink peak throughput (UPT), latency, and UL coverage. The results of the SI have been summarized in the relevant standard document (e.g. 3GPP TR 38.858). The relevant standard document includes content regarding the impact of supporting SBFD on the existing technical specifications, performance evaluation results, feasibility, and impact on radio frequency (RF) requirements. In addition, the relevant standard document includes the specification impact and performance evaluation results for potential technical improvements related to dynamic/flexible TDD.

In the conclusion of the standard document, the 3GPP has determined that Release 19should specify SBFD operations at a base station side within a TDD carrier, methods for handling gNB-to-gNB CLI and UE-to-UE CLI for SBFD operations, and RF requirements for SBFD operations at the base station. Accordingly, the 3GPP is conducting standardization of SBFD as a work item (WI) in Release 19. The core objectives and assumptions of the Release 19 SBFD WI may be as follows.
1. Requirements for SBFD operations at a base station side within a TDD Carrier
A. Semi-statically indicate a time-domain position of an SBFD subband for a terminal in radio resource control (RRC) connected mode
B. Semi-statically indicate a frequency-domain position of an SBFD subband for a terminal in RRC connected mode
C. Indicate SBFD operations for a terminal in RRC connected mode to support random access in SBFD symbols
D. Study and specify SBFD operations to support random access for a terminal in RRC idle/inactive mode, as needed
E. Specify transmission/reception and measurement behaviors and procedures in SBFD symbols and/or non-SBFD symbols for an SBFD-aware terminal
F. Basic assumptions based on related standard documents
SBFD operation at the base station side
Half-duplex operation at the UE side
Support for frequency range (FR) 1 and FR2-1
SBFD operation option 4: an SBFD-aware terminal is aware of both the temporal and frequency positions of the SBFD subband
Coexistence of non-SBFD-aware terminals (including legacy terminals) and SBFD-aware terminals in a cell where a base station operates SBFD
Operations of an SBFD scheme in which center frequencies are aligned within one pair of a configured DL bandwidth part (BWP) and a UL BWP
Allocation of one UL subband for SBFD operations within SBFD symbols in a TDD carrier (excluding existing UL symbols/slots)
SBFD operation mechanism should also consider adjacent channel coexistence between two operators
2. Specification of improvements of CLI Handling
A. Support mechanisms for co-channel CLI handling between base stations (specific mechanism to be selected among the candidates in 3GPP TR 38.858 during radio access network working group 1 (RAN 1) #117)
B. Support mechanisms for co-channel CLI handling between terminals (specific mechanism to be selected among the candidates in 3GPP TR 38.858 during RANI #117)
C. Note: apply without dedicated optimization for dynamic/flexible TDD
3. Specification of RF requirements at the base station for SBFD operations
4. Specification of core radio resource management (RRM) requirements applicable to co-channel CLI handling mechanisms
5. If other core RRM requirements for SBFD operations are identified, specify them.

As can be seen from the above-described objectives of the WI, the 3GPP has configured one of the objectives as designing co-channel CLI handling methods between base stations and co-channel CLI handling methods between terminals. The CLI handling method may be designed by selecting from candidate techniques listed in the 3GPP TR 38.858. Currently discussed candidate CLI handling techniques may include the following categories.

Candidate techniques for co-channel CLI between base stations
Measurement techniques for co-channel CLI and/or channel between base stations
Spatial domain-based techniques
Beam nulling techniques in FR1
Beam pairing techniques in FR2
Candidate techniques for co-channel CLI between terminals
Measurement and reporting techniques for co-channel CLI between terminals
D Cooperative scheduling techniques in time and/or frequency domain
Spatial domain-based techniques
Power control-based techniques

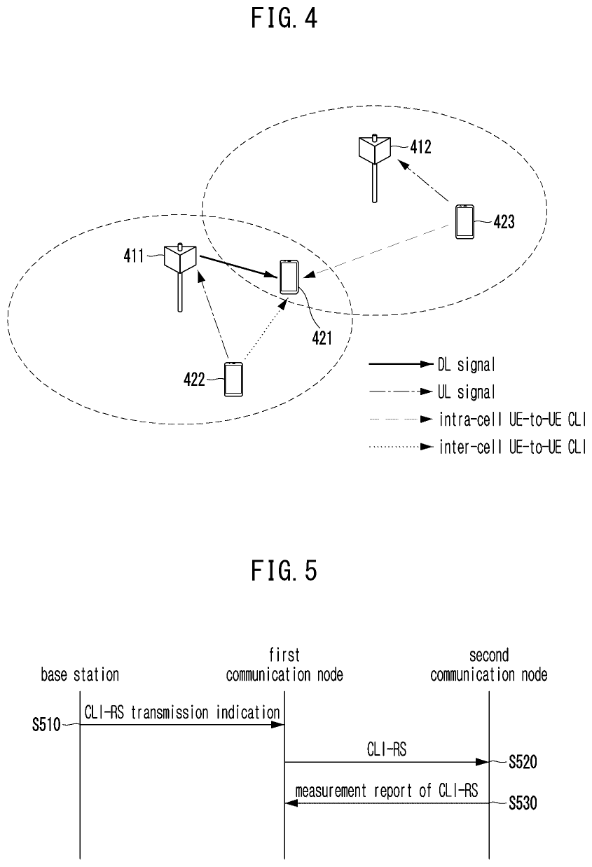

FIG. 4 is a conceptual diagram for describing UE-to-UE CLI.

Referring to FIG. 4, a communication system may include a plurality of base stations 411 and 412 and a plurality of terminals 421, 422, and 423. The first base station 411 may provide services to the first terminal 421 and the second terminal 422. For example, the first base station may transmit DL signal(s) to the first terminal and the second terminal. The first terminal and the second terminal may receive the DL signal(s) from the first base station. Each of the first terminal and the second terminal may transmit a UL signal to the first base station. The first base station may receive the UL signal from each of the first terminal and the second terminal. The second base station 412 may provide services to the first terminal 421 and the third terminal 423. For example, the second base station may transmit DL signal(s) to the first terminal and the third terminal. The first terminal and the third terminal may receive the DL signal(s) from the second base station. Each of the first terminal and the third terminal may transmit a UL signal to the second base station. The second base station may receive the UL signal from each of the first terminal and the third terminal.

UE-to-UE CLI may include inter-cell UE-to-UE CLI and intra-cell UE-to-UE CLI. The inter-cell UE-to-UE CLI may refer to CLI occurring between two terminals located in different cells. In SBFD, the base station may perform UL reception while performing DL transmission. Therefore, the UE-to-UE CLI may occur between two terminals within the same cell.

For example, the UL signal transmitted by the second terminal to the first base station may affect the DL signal received by the first terminal from the first base station and may cause interference. This interference may be referred to as intra-cell UE-to-UE CLI. The UL signal transmitted by the third terminal to the second base station may affect the DL signal received by the first terminal from the first base station and may cause interference. This interference may be referred to as inter-cell UE-to-UE CLI.

Meanwhile, a method of performing CLI measurement at a base station or a terminal may include a step of transmitting a CLI-reference signal (CLI-RS) for CLI measurement at the base station or the terminal, and a step of receiving the CLI-RS for CLI measurement at the terminal or the base station and measuring a channel or quality/strength of the CLI-RS. According to the 3GPP standard, representative indicators for signal quality/strength may be reference signal received power (RSRP) and received signal strength indicator (RSSI). The terminal may calculate RSRP or RSSI using the calculation scheme defined in 3GPP TS 38.215.

When the terminal or the base station measures RSSI for a CLI-RS, accurate timing synchronization with a first communication node transmitting the CLI-RS may not be required. However, when the terminal or the base station measures RSRP for the CLI-RS, accurate timing synchronization with the first communication node is required, and a certain level of demodulation processing may also be performed. The same may apply in a case where the terminal or the base station measures a CLI channel using the CLI-RS.

The first communication node transmitting the CLI-RS and a second communication node receiving the CLI-RS may be physically located far from each other. The CLI-RS transmitted from the first communication node may deviate from a reception timing boundary of the second communication node, and in this case, accurate measurement of RSRP for the CLI-RS or a channel may not be possible at the terminal or the base station. Such a case may occur more frequently in scenarios using a high-frequency band of FR2 in 5G NR.

In a case of using an FR2 band, the base station may set a subcarrier spacing (SCS) to at least 60 kHz. In this case, a cyclic prefix (CP) length of an OFDM symbol may become very short. For example, at an SCS of 60 kHz, the CP length may be 1.17 μs. The distance between the first communication node and the second communication node may exceed 351 m. In this case, since a propagation delay exceeds the CP, accurate RSRP and channel estimation may be difficult at the base station or the terminal.

Therefore, the present disclosure focuses on providing a method to resolve the above-described problem. The present disclosure is directed to providing accurate measurement information for CLI handling by providing transmission, reception, and measurement methods of reference signals required for CLI measurement and reporting in the wireless communication system.

Hereinafter, in describing the present disclosure, ‘configuration’ may include both configuration and pre-configuration. In addition, ‘and/or’ in the present disclosure may be interpreted to mean either or both of two elements, and in the present disclosure, the expression ‘A includes B and C’ should be interpreted as ‘A includes B and C but is not limited thereto’. When describing various examples in the present disclosure, ‘method A, method B, method C, etc.’ should be interpreted as ‘including method A, method B, and method C, and not limited thereto, and may further include an additional method D’.

In the present disclosure, the base station or the terminal may refer to a communication node or an antenna of a communication node including a gNodeB (gNB), an eNodeB (eNB), a transmission reception point (TRP), a fixed/mobile relay, a Wi-Fi access point (Wi-Fi AP), or a terminal. That is, although a communication scenario between a base station and a terminal is mainly described for convenience of description, the present disclosure may also be applied to various communication methods including a communication scenario between a Wi-Fi AP and a Wi-Fi terminal, a device-to-device (D2D) communication method, or a sidelink (SL) communication method.

Therefore, although DL, UL, and other terms related to general cellular communication are used in the following description of the present disclosure, the description is not limited only to cellular communication and is equally applicable to various wireless communication systems including Wi-Fi. In addition, the base station and the terminal may include communication nodes mounted on aircraft, ships, satellites, high altitude platform stations (HAPS), or unmanned aerial vehicles/drones.

In addition, although the description in the present disclosure is based on SBFD, it may not exclude application to an in-band full duplex scheme. Signaling in the present disclosure may include RRC, master information block (MIB), system information block (SIB), DL/UL/SL control information (DCI/UCI/SCI), and medium access control (MAC) control element (CE) in a Uu link or sidelink, and is not limited thereto.

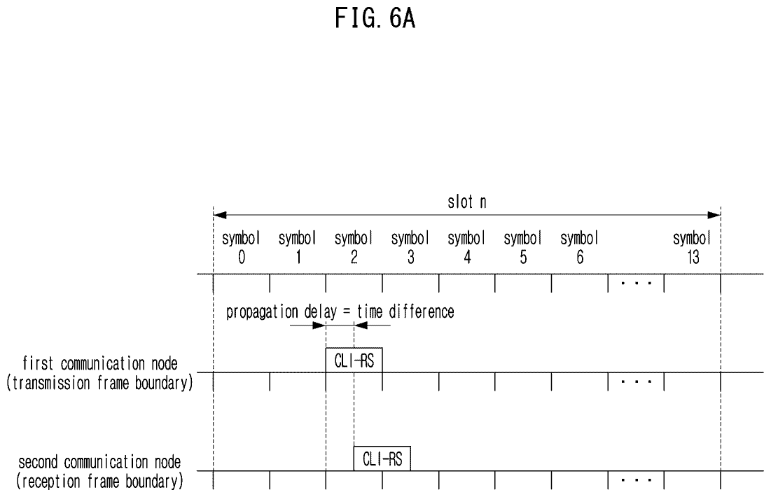

FIG. 5 is a sequence chart illustrating exemplary embodiments of a method for measuring and reporting UE-to-UE CLI in a communication system.

Referring to FIG. 5, in a method for measuring and reporting UE-to-UE CLI, a communication system may include a plurality of base stations and a plurality of terminals. A first base station may provide services to a first terminal and a second terminal. For example, the first base station may transmit DL signal(s) to the first terminal and the second terminal. The first terminal and the second terminal may receive the DL signal(s) from the first base station. Each of the first terminal and the second terminal may transmit a UL signal to the first base station. The first base station may receive the UL signal from each of the first terminal and the second terminal. A second base station may provide services to the first terminal and a third terminal. For example, the second base station may transmit DL signal(s) to the first terminal and the third terminal. The first terminal and the third terminal may receive the DL signal(s) from the second base station. Each of the first terminal and the third terminal may transmit a UL signal to the second base station. The second base station may receive the UL signal from each of the first terminal and the third terminal.

In the method for measuring and reporting cross-link interference between terminals, terminals may be classified into a first communication node that transmits a CLI-RS and a second communication that receives the CLI-RS and performs measurement. For example, the first terminal may correspond to the second communication node, and each of the second terminal and the third terminal may correspond to the first communication node. The first communication node may be an aggressor terminal (i.e. ‘Agg-UE’) that generates CLI signals. The second communication node may be a victim terminal (i.e. ‘Vic-UE’) affected by CLI. The aggressor terminal may be a terminal that causes UE-to-UE CLI. Alternatively, the aggressor terminal may be a terminal that may cause UE-to-UE CLI. The victim terminal may be a terminal affected by UE-to-UE CLI. Alternatively, the victim terminal may be a terminal that may be affected by UE-to-UE CLI.

The first communication node and the second communication node may be located in different cells. The first communication node and the second communication node may cause inter-cell UE-to-UE CLI. The first base station to which the second communication node belongs and the second base station to which the first communication node belongs may exchange information related to CLI-RS transmission resources. Alternatively, the first communication node and the second communication node may be located within the same cell. The first communication node and the second communication node may cause intra-cell UE-to-UE CLI.

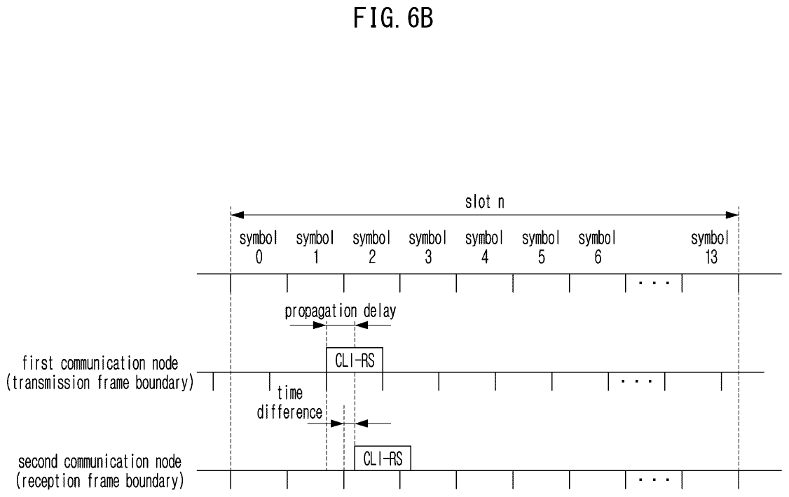

FIGS. 6A and 6B are conceptual diagrams for describing exemplary embodiments for alignment of a transmission frame boundary and a reception frame boundary.

Referring to FIG. 6A, a transmission frame boundary of the first communication node and a reception frame boundary of the second communication node may be aligned. In this case, a propagation delay and a time difference may be the same. Referring to FIG. 6B, a transmission frame boundary of the first communication node and a reception frame boundary of the second communication node may not be aligned. In this case, a propagation delay and a time difference may not be the same.

Referring again to FIG. 5, in the method for measuring and reporting UE-to-UE CLI, a base station may transmit a CLI-RS transmission indication signal to the first communication node. The first communication node may receive the CLI-RS transmission indication signal from the base station (S510). The base station may be the first base station or the second base station. Additionally or alternatively, the second communication node may transmit a CLI-RS transmission indication signal to the first communication node. The first communication node may receive the CLI-RS transmission indication signal from the second communication node.

The first communication node may transmit a CLI-RS for UE-to-UE CLI measurement to the second communication node (S520). The first communication node may configure an extended CP for all symbols of a slot used for CLI-RS transmission. Alternatively, the first communication node may configure an extended CP for some symbols within the slot, including CLI-RS symbols, used for CLI-RS transmission. A base station may configure the CLI-RS transmitted by the first communication node as a cell-specific RS or UE-specific RS. Here, the base station may be the first base station or the second base station. The types of CLI-RS may be classified as follows.
Sounding reference signal (SRS)
Physical UL control channel (PUCCH)

For example, the PUCCH may have a PUCCH format 0.
Demodulation reference signal (DMRS) of a PUCCH or physical uplink shared channel (PUSCH)
Physical random access channel (PRACH)

The first communication node may transmit the CLI-RS in a periodic, aperiodic, or semi-persistent manner. When the first communication node transmits the CLI-RS, a conflict may occur with UL transmission or DL reception. The first communication node may operate according to one of operations below.
The base station may configure the first communication node to perform UL transmission and CLI-RS transmission simultaneously through signaling such as RRC, DCI, or MAC CE. In this case, the first communication node may perform both UL transmission and CLI-RS transmission simultaneously.
The base station may configure the first communication node to omit UL transmission or DL reception and to transmit the CLI-RS through signaling such as RRC, DCI, or MAC CE. In this case, the first communication node may omit UL transmission or DL reception and transmit the CLI-RS.
The base station may configure the first communication node to omit CLI-RS transmission and to perform UL transmission or DL reception through signaling such as RRC, DCI, or MAC CE. In this case, the first communication node may omit CLI-RS transmission and perform UL transmission or DL reception.
The base station may configure priority values for UL transmission, DL reception, and CLI-RS transmission to the first communication node through signaling such as RRC, DCI, or MAC CE, and may configure the first communication node to determine an operation based on the priority values. The first communication node may select and perform one operation among UL transmission, DL reception, and CLI-RS transmission based on the configured priority values.

The second communication node may receive the CLI-RS from the first communication node and may perform CLI measurement on the received CLI-RS. The second communication node may perform CLI measurement on the entire or a part of resources of a CLI measurement band. The CLI measurement band may include a DL/UL BWP or a DL/UL subband. For example, the second communication node may receive the CLI-RS from the first communication node using the entire or a part of the resources of an active DL BWP and may perform CLI measurement accordingly.

The second communication node may measure a received signal strength for the CLI-RS received from the first communication node. For example, the received signal strength may be RSRP or RSSI. The second communication node may deliver the measured RSRP or RSSI for the CLI-RS to the first communication node. The first communication node may receive the RSRP or RSSI for the CLI-RS from the second communication node.

The first communication node and the second communication node may dynamically adjust a transmission timing and/or reception timing prior to performing measurement for the CLI-RS. The first communication node and the second communication node may perform the measurement for the CLI-RS after dynamically adjusting the transmission timing and/or reception timing of the CLI-RS. The base station may transmit a CLI-RS transmission indication signal to the first communication node. The CLI-RS transmission indication signal may include information on a transmission time of the CLI-RS. The first communication node may receive the CLI-RS transmission indication signal from the base station. The base station may be the first base station or the second base station. Additionally or alternatively, the second communication node may transmit a CLI-RS transmission indication signal to the first communication node. The first communication node may receive the CLI-RS transmission indication signal from the second communication node. The base station may transmit information on the transmission time of the CLI-RS to the second communication node. In a case for measuring intra-cell UE-to-UE CLI, the base station may be the first base station. On the other hand, in a case for measuring inter-cell UE-to-UE CLI, the base station may be the second base station. The second base station may deliver information on the transmission time of the CLI-RS to the second communication node via the first base station. The second communication node may receive the information on the transmission time of the CLI-RS from the base station.

The first communication node may transmit the CLI-RS (e.g. PRACH or SRS) to the second communication node. The second communication node may receive the CLI-RS from the first communication node. The second communication node may measure a time difference T_{diff} caused by various factors including a physical distance between the second terminal and the first terminal. For example, the second communication node may recognize a reception time of the CLI-RS. The second communication node may determine a time difference between a reception frame boundary and the reception time of the CLI-RS. As another example, the second communication node may identify the transmission time of the CLI-RS through the information on the transmission time of the CLI-RS. The second communication node may recognize the reception time of the CLI-RS. The second communication node may determine a propagation delay by subtracting the reception time of the CLI-RS from the transmission time of the CLI-RS. The transmission frame boundary of the first communication node and the reception frame boundary of the second communication node may be aligned. In this case, the propagation delay and the time difference may be the same. That is, the time difference T_{diff} may be the propagation delay value of the CLI-RS measured at the second communication node. The second communication node may quantize the measured time difference to convert a result of the quantization into a first timing advance value TA_{CLI-RS} for the CLI-RS. The second communication node may report TA_{CLI-RS} to the first communication node. The first timing advance value may be referred to as a timing adjustment value. The first timing advance value may be referred to as a timing value to be used.

TA_{CLI-RS} may be a value derived from the time difference at the second communication node through a quantization process or similar processes, so that it can be matched to the number of available bits for reporting. The second communication node may deliver TA_{CLI-RS} to the first communication node through a direct link such as a sidelink. Alternatively, the second communication node may report TA_{CLI-RS} to the base station. The base station may receive TA_{CLI-RS} from the second communication node, and may deliver TA_{CLI-RS} to the first communication node. The first communication node may receive TA_{CLI-RS} from the base station.

The first communication node and the second communication node may be located in different cells. The first communication node may be located in the second base station, and the second communication node may be located in the first base station. The second communication node may deliver TA_{CLI-RS} to the first base station. The first base station may receive TA_{CLI-RS} from the second communication node. The first base station may deliver TA_{CLI-RS} received from the second communication node to the second base station of the first communication node. The second base station may receive TA_{CLI-RS} from the first base station. The second base station may deliver the received TA_{CLI-RS} to the first communication node. The first communication node may receive TA_{CLI-RS} from the second base station. The second base station of the first communication node may deliver TA_{CLI-RS} to the first communication node through signaling. The first communication node may receive TA_{CLI-RS} from the second base station.

The first communication node may perform timing advance (TA) for CLI-RS transmission based on the signaling from the second communication node or the base station. Alternatively, the first communication node may perform TA for CLI-RS transmission based on its own determination. The first communication node may perform TA based on TA_{CLI-RS} received from the second base station or the second communication node. In the case where the first communication node directly receives TA_{CLI-RS} from the second communication node, the first communication node may perform TA by directly applying TA_{CLI-RS} to a transmission timing. In the case where the first communication node directly receives TA_{CLI-RS} from the second communication node, the first communication node may additionally perform quantization on TA_{CLI-RS} to derive a second timing advance value [symbol] _{CLI-RS}. The first timing advance value and the second timing advance value may be set to the same value. The first communication node may perform TA by applying [symbol] _{CLI-RS} to a transmission timing of the CLI-RS. The second timing advance value may be a timing adjustment value. The second timing advance value may be a timing value to be used.

The second base station of the first communication node may additionally perform quantization on TA_{CLI-RS} to derive a third timing advance value [symbol] CLI-RS. The second base station may deliver [symbol] _{CLI-RS} to the first communication node through signaling. The first communication node may receive [symbol] _{CLI-RS} from the second base station. The first timing advance value and the third timing advance value may be set to the same value. The first timing advance value and the third timing advance value may be as shown in Table 1 below. The third timing advance value may be a timing adjustment value. The third timing advance value may be a timing value to be used.

TABLE 1

| A range of the first timing advance value | Third timing advance value |
|---|---|
| 0~15 | 0 |
| 16-31 | 16 |
| 32-47 | 32 |
| 48-79 | 48 |
| 80-95 | 80 |
| 96-111 | 96 |
| 112-127 | 112 |
| 128-143 | 128 |
| 144-159 | 144 |
| 160-175 | 160 |
| 176-191 | 176 |
| 192-207 | 192 |
| 208-223 | 208 |
| 224-239 | 224 |
| 240-355 | 240 |

For example, the second base station of the first communication node may convert the first timing advance value of 8 bits (i.e. 0˜255) into the third timing advance value of 4 bits (0,16, 32, . . . , 240). The second base station of the first communication node may deliver the third timing advance value to the first communication node. This may reduce the number of bits required for the second base station to notify the TA value to the first communication node.

The first communication node may perform TA for CLI-RS transmission based on signaling from the second communication node or the second base station. The first communication node may perform TA for CLI-RS transmission basically based on its own determination. The first communication node may perform TA based on [symbol] _{CLI-RS} received from the second base station. [symbol] _{CLI-RS} and [symbol] _{CLI-RS} may be set to the same value as TA_{CLI-RS}. [symbol] _{CLI-RS} and [symbol] _{CLI-RS} may be values derived from TA_{CLI-RS} through additional quantization or other processes.

Meanwhile, instead of TA_{CLI-RS}, [symbol] CLI-RS, or [symbol] CLI-RS, signaling based on a difference (error value) between a timing advance (TA_{UL}) for UL transmission and a timing advance (TA_{CLI-RS}) for CLI-RS transmission may be applied. For example, TA_{CLI-RS} may be expressed as TA_{UL}+δ_{CLI-RS}. TA_{UL} may be a UL timing advance for UL transmission. The second communication node may calculate an error value δ_{CLI-RS} based on TA_{CLI-RS} and TA_{UL}. The error value may be a value needed to derive the timing advance for CLI-RS transmission from the timing advance for UL transmission. The error value may be a timing value to be used. The second communication node may deliver δ_{CLI-RS} to the first communication node through a direct link such as a sidelink. Alternatively, the second communication node may report δ_{CLI-RS} to the base station. The base station may receive δ_{CLI-RS} from the second communication node, and deliver δ_{CLI-RS} to the first communication node. The first communication node may receive δ_{CLI-RS} from the base station.

The first communication node and the second communication node may be located in different cells. The first communication node may be located in the second base station, and the second communication node may be located in the first base station. The second communication node may deliver δ_{CLI-RS} to the first base station. The first base station may receive δ_{CLI-RS} from the second communication node. The first base station may deliver δ_{CLI-RS}, which is received from the second communication node, to the second base station of the first communication node. The second base station may receive δ_{CLI-RS} from the first base station, and deliver δ_{CLI-RS} to the first communication node. The first communication node may receive δ_{CLI-RS} from the second base station. The first communication node may calculate TA_{CLI-RS} based on δ_{CLI-RS} .

The first communication node may perform TA for CLI-RS transmission based on signaling from the second communication node or the base station. The first communication node may perform TA for CLI-RS transmission basically based on its own determination. The first communication node may perform TA based on TA_{CLI-RS}. The first communication node may perform TA by applying TA_{CLI-RS} to the transmission timing of the CLI-RS. Alternatively, the first communication node may further calculate [symbol] _{CLI-RS} using TA_{CLI-RS}. The first communication node may perform TA by applying [symbol] _{CLI-RS} to the transmission timing of the CLI-RS. When δ_{CLI-RS}=0, the UL transmission timing and the CLI-RS transmission timing of the first communication node may be the same.

When the first communication node transmits a CLI-RS based on signaling from the base station, the first communication node may transmit the CLI-RS to the second communication node by applying the same timing advance value as that of its UL transmission to the transmission time of the CLI-RS. Alternatively, when the first communication node transmits a CLI-RS based on signaling from the base station, the first communication node may transmit the CLI-RS by applying a timing advance value different from that of its UL transmission to the transmission time of the CLI-RS.

The base station of the first communication node may instruct the first communication node to transmit a CLI-RS. The base station of the first communication node may inform a measurement purpose for the CLI-RS to the first communication node. The measurement purpose may be to measure CLI-RSRP/RSRQ or a CLI radio channel from the CLI-RS. The first communication node may receive the CLI-RS transmission indication and information on the measurement purpose from the base station. The first communication node may receive, from the base station, the measurement purpose indicating that CLI-RSRP/RSRQ or CLI radio channel is to be measured. The first communication node may transmit the CLI-RS to the second communication node by applying TA_{CLI-RS}. However, even in this case, the first communication node may transmit the CLI-RS to the second communication node by applying TA_{UL}.

The base station of the first communication node may instruct the first communication node to transmit a CLI-RS. In this case, the base station of the first communication node may inform a measurement purpose for the CLI-RS to the first communication node. The measurement purpose may be to measure CLI-RSSI from the CLI-RS. The base station may deliver, through signaling, information on a timing value to used, so that at least one of TA_{UL}, TA_{CLI-RS} or δ_{CLI-RS} is to be utilized in TA for the CLI-RS. The first communication node may receive the CLI-RS transmission indication, information on the measurement purpose, and information on the timing value to be used from the base station. The first communication node may receive, from the base station, the measurement purpose indicating that CLI-RSSI is to be measured. The first communication node may transmit the CLI-RS to the second communication node by applying the used timing value. However, the first communication node may not receive information on the timing value to be used from the base station. In this case, the first communication node may transmit the CLI-RS to the second communication node by applying TA_{UL}.

TA_{UL} and TA_{CLI-RS} of the first communication node may be the same. Alternatively, δ_{CLI-RS} may be within a range allowable by the base station. The first communication node may transmit a CLI-RS to the second communication node by applying a fourth timing advance value TA_{CLI-RS+UL} for both UL transmission and CLI-RS transmission. The fourth timing advance value may be a timing adjustment value. The fourth timing advance value may be referred to as a timing value to be used.

The first communication node may calculate TA_{CLI-RS+UL} based on TA_{UL} and TA_{CLI-RS}. For example, TA_{CLI-RS+UL} may be identical to TA_{UL} or TA_{CLI-RS}. Alternatively, TA_{CLI-RS+UL} may be set as an average value of TA_{UL} and TA_{CLI-RS}. δ_{CLI-RS} may exceed the range allowable by the base station. In this case, the first communication node may omit UL transmission or CLI-RS transmission. The first communication node may adjust the transmission timing of the CLI-RS in units of slots or symbols. The second communication node may adjust the reception timing of the CLI-RS in units of slots or symbols.

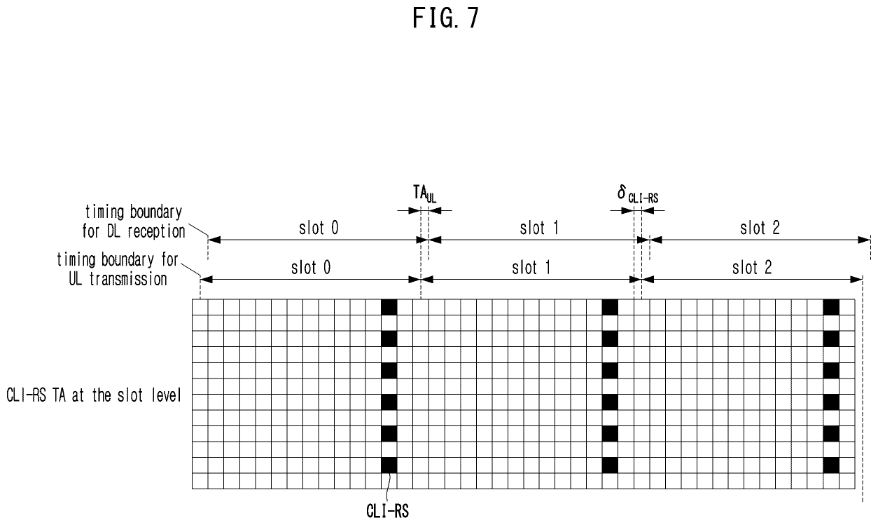

FIG. 7 is a conceptual diagram for describing exemplary embodiments of a timing advance of a reference signal for CLI measurement in units of slots.

Referring to FIG. 7, the first communication node may adjust the transmission timing of the CLI-RS in units of slots. The second communication node may adjust the reception timing of the CLI-RS in units of slots. The base station may provide, through signaling, the first communication node and the second communication node with information on a symbol structure (e.g. the position and number of guard symbols) for CLI-RS TA at the slot level. The first communication node and the second communication node may receive, from the base station, information on the symbol structure for CLI-RS TA at the slot level.

The first communication node may perform TA by applying a timing adjustment value to a timing boundary for UL transmission in units of slots, so that transmission is advanced by the timing adjustment value. The timing adjustment value may be the error δ_{CLI-RS}. The second communication node may perform TA by applying a timing adjustment value to a timing boundary for DL reception in units of slots, so that reception is delayed by the timing adjustment value. The timing adjustment value may be the error δ_{CLI-RS}.

On the other hand, the first communication node may not perform TA for the CLI-RS. The second communication node may receive the CLI-RS transmitted by the first communication node. The second communication node may obtain a reception timing boundary for CLI-RS measurement based on the received CLI-RS and update it periodically or aperiodically. The reception timing of the CLI-RS may differ from a DL reception timing of the second communication node.

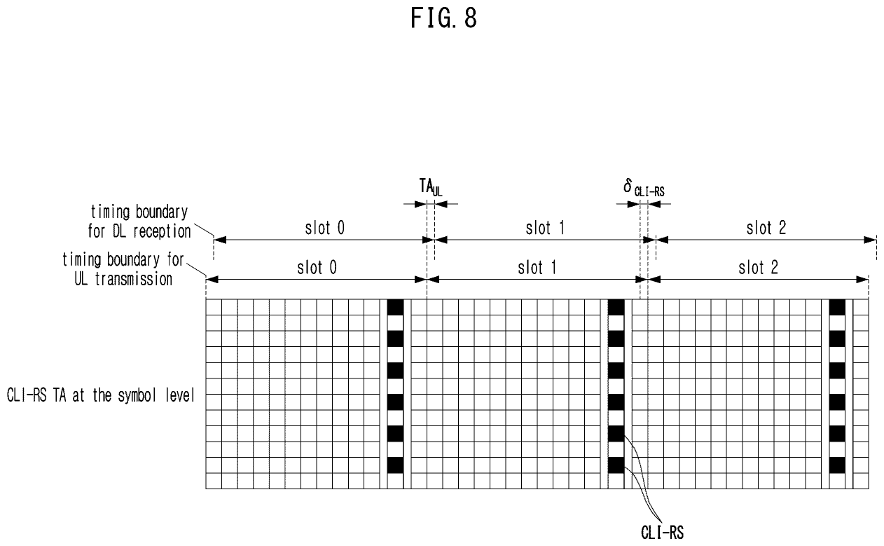

FIG. 8 is a conceptual diagram for describing exemplary embodiments of a timing advance of a reference signal for CLI measurement in units of symbols.

Referring to FIG. 8, the first communication node may adjust the transmission timing of the CLI-RS in units of symbols, and the second communication node may adjust the reception timing of the CLI-RS in units of symbols. For example, the first communication node may adjust the transmission timing of the CLI-RS at the symbol level by configuring one or more symbols located before or after a CLI-RS symbol as guard symbols based on a timing adjustment value. The timing adjustment value may be the error δ_{CLI-RS}. In other words, the first communication node may configure one or more symbols located before or after the CLI-RS symbol as guard symbols. The first communication node may apply the timing adjustment value to the transmission timing of the CLI-RS so that the transmission timing of the CLI-RS is advanced or delayed within a section of the guard symbol(s). The first communication node may transmit the CLI-RS to the second communication node at the determined transmission timing of the CLI-RS.

The second communication node may allocate resources for one or more symbols located before or after the CLI-RS symbol resource as resources for guard symbols based on a timing adjustment value to adjust the reception timing of the CLI-RS at the symbol level. The timing adjustment value may be the error δ_{CLI-RS}. In other words, the second communication node may allocate resources for one or more symbols located before or after a CLI-RS symbol resource as resources for guard symbols. The second communication node may apply the timing adjustment value to the reception timing of the CLI-RS so that the reception timing of the CLI-RS is advanced or delayed within a section of the guard symbol(s). The second communication node may receive the CLI-RS from the first communication node at the determined reception timing of the CLI-RS.

The base station may transmit, through signaling, information on a symbol structure (e.g. the position and number of guard symbols) for CLI-RS TA at the symbol level to the second communication node and the first communication node. The second communication node and the first communication node may receive, from the base station, information on the symbol structure for CLI-RS TA at the symbol level.

On the other hand, the first communication node may not perform TA for the CLI-RS. The second communication node may receive the CLI-RS transmitted by the first communication node. The second communication node may obtain a reception timing boundary for CLI-RS measurement based on the received CLI-RS and update it periodically or aperiodically. The reception timing of the CLI-RS may differ from a DL reception timing of the second communication node.

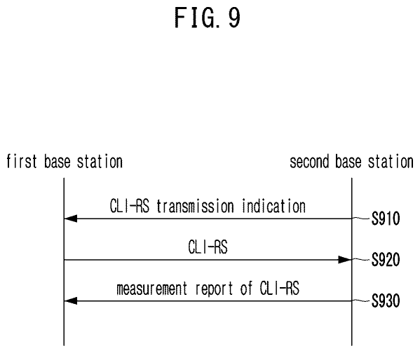

FIG. 9 is a sequence chart illustrating exemplary embodiments of a method for measuring and reporting gNB-to-gNB CLI in a communication system.

Referring to FIG. 9, in a method for measuring and reporting gNB-to-gNB CLI, a communication system may include a plurality of base stations and a plurality of terminals. A first base station may provide a service to a first terminal. For example, the first base station may transmit a DL signal to the first terminal. The first terminal may receive the DL signal from the first base station. The first terminal may transmit a UL signal to the first base station. The first base station may receive the UL signal from the first terminal. A second base station may provide a service to a second terminal. For example, the second base station may transmit a DL signal to the second terminal. The second terminal may receive the DL signal from the second base station. The second terminal may transmit a UL signal to the second base station. The second base station may receive the UL signal from the second terminal.

In a method for measuring and reporting gNB-to-gNB CLI, the first base station and the second base station may exchange resource configuration information for CLI measurement. Both the first base station and the second base station may be aggressor base stations (i.e. Agg-gNB) that generate CLI signals. The first base station and the second base station may be victim base stations (i.e. Vic-gNB) affected by CLI.

Here, the aggressor base station may be affecting gNB-to-gNB CLI. The aggressor base station may affect gNB-to-gNB CLI. The victim base station may be being affected by gNB-to-gNB CLI. The victim base station may be affected by gNB-to-gNB CLI. When the first base station is an aggressor base station, the second base station may be a victim base station. When the first base station is a victim base station, the second base station may be an aggressor base station.

In the method for measuring and reporting gNB-to-gNB CLI, the second base station may transmit a CLI-RS transmission indication signal to the first base station (S910). Then, the first base station may receive the CLI-RS transmission indication signal from the second base station. The first base station may transmit a CLI-RS for gNB-to-gNB CLI measurement to the second base station (S920). The first base station may transmit a CLI-RS for gNB-to-gNB CLI measurement to the second base station even when the first base station does not receive a CLI-RS transmission indication signal from the second base station. The first base station may configure an extended CP for all symbols within a slot used for CLI-RS transmission. The first base station may configure an extended CP for some symbols within the slot, including CLI-RS symbols, used for CLI-RS transmission.

The second base station may request the first base station to transmit a CLI-RS in a periodic, aperiodic manner, or semi-persistent manner. The first base station may transmit a CLI-RS to the second base station in a periodic, aperiodic manner, or semi-persistent manner. The second base station may predict or preconfigure radio resources for CLI-RS reception.

The second base station may transmit information on predicted or preconfigured radio resources for CLI-RS reception to the first base station. The first base station may receive, from the second base station, information on predicted or preconfigured radio resources for CLI-RS reception. The first base station may use the radio resources corresponding to the received information on predicted or preconfigured radio resources for CLI-RS reception to transmit the CLI-RS to the second base station. The second base station may receive the CLI-RS from the first base station through the predicted or preconfigured radio resources for CLI-RS reception.

For example, the second base station may not allocate certain frequency resources after 20 slots to UL reception and may preconfigure the resources as radio resources for CLI-RS reception. The second base station may transmit information on the certain frequency resources after 20 slots for CLI-RS reception to the first base station. The first base station may receive, from the second base station, information on the frequency resources after 20 slots as information on predicted or preconfigured radio resources for CLI-RS reception. The first base station may use the radio resources corresponding to the received information on frequency resources after 20 slots to transmit the CLI-RS to the second base station. The second base station may receive the CLI-RS from the first base station through the predicted or preconfigured radio resources for CLI-RS reception.

The radio resources for CLI-RS reception may include time resources (e.g. DL/UL slots), frequency resources (e.g. specific DL/UL BWP, DL/UL subbands, DL/UL resource blocks), code resources, and beam resources (e.g. UL reception beams) that are not used for DL/UL.

The second base station may receive the CLI-RS from the first base station and measure a received signal strength of the CLI-RS. The received signal strength may be RSRQ or RSSI. The second base station may transmit the measured received signal strength to the first base station (S930). The first base station may receive the received signal strength from the second base station.

The first base station and the second base station may dynamically adjust a transmission timing and/or reception timing of the CLI-RS. The first base station may adjust the transmission timing of the CLI-RS in units of slots or symbols. The second base station may adjust the reception timing of the CLI-RS in units of slots or symbols. For example, the first base station may adjust the transmission timing of the CLI-RS at the symbol level by configuring one or more symbols located before or after the CLI-RS symbol as guard symbols. That is, the second base station may allocate resources for one or more symbols located before or after the CLI-RS symbol resource as guard symbol resources. The second base station may apply a timing adjustment value to the reception timing of the CLI-RS so that the reception timing of the CLI-RS is advanced or delayed within a section of the guard symbol(s). The second base station may receive the CLI-RS from the first base station at the determined reception timing of the CLI-RS.

The second base station may periodically or aperiodically receive the CLI-RS from the first base station and acquire the reception timing of the CLI-RS transmitted by the first base station. The CLI-RS used in this case may include a synchronization signal block (SSB). The SSB may be a general SSB. The SSB may be a CLI-RS reception timing acquisition-dedicated SSB designed to acquire the reception timing required for CLI-RS reception at the second base station. For example, the CLI-RS reception timing acquisition-dedicated SSB may be composed only of a primary synchronization signal (PSS) and/or a secondary synchronization signal (SSS) without a physical broadcast channel (PBCH).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
transmitting a first cross-link interference-reference signal (CLI-RS) to a second communication node;
receiving a first timing adjustment value based on the first CLI-RS from the second communication node or a third communication node;
adjusting a transmission timing based on the first timing adjustment value;
transmitting a second CLI-RS to the second communication node based on the adjusted transmission timing; and
receiving a received signal strength for the second CLI-RS from the second communication node.

2. The method according to claim 1, wherein each of the first CLI-RS and the second CLI-RS is at least one of a sounding reference signal (SRS), a physical uplink control channel (PUCCH), a demodulation reference signal (DMRS) of a PUCCH, a DMRS of a physical uplink shared channel (PUSCH), or a physical random access channel (PRACH).

3. The method according to claim 1, further comprising:
before transmitting the first CLI-RS, receiving a transmission indication signal for the first CLI-RS from a base station; and
before transmitting the second CLI-RS, receiving a transmission indication signal for the second CLI-RS from the base station.

4. The method according to claim 1, wherein the adjusting of the transmission timing based on the first timing adjustment value comprises:
deriving a second timing adjustment value by applying the first timing adjustment value to an uplink timing advance value; and
adjusting the transmission timing by using the second timing adjustment value.

5. The method according to claim 4, wherein in the adjusting of the transmission timing based on the second timing adjustment value, the first communication node configures one or more symbols located before or after a symbol of the second CLI-RS as guard symbols, and adjusts a transmission timing of the symbol of the second CLI-RS within a section of the guard symbols by applying the second timing adjustment value.

6. The method according to claim 1, wherein in the adjusting of the transmission timing based on the first timing adjustment value, the first communication node adjusts the transmission timing by applying the first timing adjustment value in units of slots.

7. The method according to claim 1, wherein the first CLI-RS and the second CLI-RS are transmitted in a periodic, aperiodic or semi-persistent manner.

8. The method according to claim 1, wherein the received signal strength is at least one of a reference signal received power (RSRP), a reference signal received quality (RSRP), or a received signal strength indication (RSSI).

9. A method of a second communication node, comprising:
receiving a first cross-link interference-reference signal (CLI-RS) from a first communication node;
deriving a timing adjustment value based on the first CLI-RS;
transmitting the timing adjustment value to the first communication node;
receiving a second CLI-RS from the first communication node;
measuring a received signal strength for the second CLI-RS; and
transmitting the received signal strength to the first communication node or a third communication node.

10. The method according to claim 9, wherein the deriving of the timing adjustment value based on the first CLI-RS comprises:
measuring a reception time of the first CLI-RS;
deriving a time difference using a reception boundary and the reception time; and
deriving the timing adjustment value by quantizing the time difference.

11. The method according to claim 9, wherein the deriving of the timing adjustment value comprises:
measuring a reception time of the first CLI-RS;
deriving a time difference using a reception boundary and the reception time;
deriving a timing advance value by quantizing the time difference; and
configuring an error value between an uplink timing advance value and the timing advance value as the timing adjustment value.

12. The method according to claim 9, wherein the timing adjustment value is transmitted to the first communication node via the third communication node.

13. The method according to claim 9, wherein an interference measurement band of the second CLI-RS is at least one of a downlink bandwidth part (BWP), an uplink BWP, a downlink subband, or an uplink subband.

14. The method according to claim 9, further comprising: before receiving the second CLI-RS, adjusting a reception timing based on the timing adjustment value.

15. The method according to claim 14, wherein the reception timing is adjusted in units of symbols or slots.

16. A first communication comprising: at least one processor, wherein the at least one processor causes the first communication node to perform:
transmitting a first cross-link interference-reference signal (CLI-RS) to a second communication node;
receiving a first timing adjustment value based on the first CLI-RS from the second communication node or the third communication node;
adjusting a transmission timing based on the first timing adjustment value;
transmitting a second CLI-RS to the second communication node based on the adjusted transmission timing; and
receiving a received signal strength for the second CLI-RS from the second communication node.

17. The first communication node according to claim 16, wherein in the adjusting of the transmission timing based on the first timing adjustment value, the at least one processor causes the first communication node to perform:
deriving a second timing adjustment value by applying the first timing adjustment value to an uplink timing advance value; and
adjusting the transmission timing by using the second timing adjustment value.

18. The first communication node according to claim 16, wherein in the adjusting of the transmission timing based on the first timing adjustment value, the at least one processor causes the first communication node to adjust the transmission timing by applying the first timing adjustment value in units of slots.
